(19) United States
(12) Patent Application Publication
(10) Pub. No.: US 2015/0254783 A1
(43) Pub. Date: Sep. 10, 2015

(54) SYSTEMS AND METHODS FOR ESTATE ACCOUNT DISCOVERY

(71) Applicant: Estate Assist, Inc., San Francisco, CA (US)

(72) Inventors: Woodrow H. Levin, San Francisco, CA (US); Joseph G. Moss, Danville, CA (US)

(73) Assignee: ESTATE ASSIST, INC., San Francisco, CA (US)

(21) Appl. No.: 14/535,964

(22) Filed: Nov. 7, 2014

Related U.S. Application Data
(63) Continuation-in-part of application No. 14/329,173, filed on Jul. 11, 2014.
Application No. 14/329,173 is a continuation-in-part of application No. 14/329,152, filed on Jul. 11, 2014.
(60) Provisional application No. 61/949,900, filed on Mar. 7, 2014.
(60) Provisional application No. 61/949,894, filed on Mar. 7, 2014.

(51) Int. Cl. G06Q 40/00; G06Q 50/18

(52) U.S. Cl. CPC G06Q 40/12; G06Q 50/186

(57) ABSTRACT

A system comprises a processor; a communications engine for receiving a request to determine potential service provider accounts that a user has with one or more service providers and for obtaining financial data records of the user from an API that obtains the financial data records from a financial provider system, each respective financial data record corresponding to a respective transaction and including a respective date, amount, and party identifier corresponding to a respective party associated with the respective transaction; a confidence score determination engine for evaluating the financial data records to generate a particular confidence score corresponding to a particular party, the particular confidence score indicating a likelihood that the user has a service provider account with the particular party; and a potential service provider account identification engine for identifying the potential service provider account based on the particular confidence score.

### CROSS-REFERENCE TO RELATED APPLICATIONS

This application is a continuation-in-part of U.S. Nonprovisional patent application Ser. No. 14/329,173, filed Jul. 11, 2014, entitled “AUTOMATED ESTATE MANAGEMENT,” which claims benefit of U.S. Provisional Patent Application Serial No. 61/949,900, filed Mar. 7, 2014, entitled “ESTATE MANAGEMENT,” and a continuation-in-part of U.S. Nonprovisional patent application Ser. No. 14/329,152, filed Jul. 11, 2014, entitled “ESTATE ACCOUNT MANAGEMENT,” which claims benefit of U.S. Provisional Patent Application Ser. No. 61/949,894, filed Mar. 7, 2014, entitled “ORGANIZING, TRANSMITTING, OR CLOSING ACCOUNTS ASSOCIATED WITH AN ESTATE,” all of which are hereby incorporated by reference.

### BACKGROUND

Individuals often have service accounts with service providers. These service accounts may be for home phones, mobile phones, cable television, satellite television, online services, utilities, banking services, garbage services, home insurance, life insurance, car insurance, and the like. In fact, some individuals may have multiple service accounts with a single service provider. When an individual passes away, the survivors often have to dig through boxes of documents and financial records to try to identify these service contracts. The survivors often have to make phone calls to service providers to ask whether such accounts exist, and to monitor incoming mail. This is a tedious and ineffective process. It would be helpful if there were systems and methods capable of assisting individuals and/or survivors to identify service accounts more effectively.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

Systems and methods of the present invention examine financial data records of an individual and using a series of automated rules and algorithms make highly intelligent determinations about what transactions are due to a likely service provider account. Crowd-sourced data and/or curation behavior can assist the systems and methods to improve its identification of likely service providers.

In some embodiments, a system comprises at least one processor; at least one communications engine executable by the at least one processor for receiving a request to determine potential service provider accounts that a user has with one or more service providers and for obtaining financial data records of the user from an application programming interface that obtains the financial data records of the user from a financial provider system, each respective financial data record corresponding to a respective transaction and including a respective date, a respective amount, and a respective party identifier corresponding to a respective party associated with the respective transaction; a confidence score determination engine executable by the at least one processor for evaluating the financial data records to generate at least one confidence score corresponding to at least one party, the confidence score indicating the likelihood that the user has a service provider account with the party; and a potential service provider account identification engine executable by the at least one processor for identifying the potential service provider account based on the at least one confidence score.

The confidence score determination engine may generate each confidence score based on gaps between transactions and variance in transaction amounts. The financial data records of the user may include at least three months of financial data records of the user. The system may further comprise an estate account learning engine executable by the at least one processor for identifying party identifiers who are highly unlikely to correspond to service providers. Each financial data record may further include a category. The party identifiers who are unlikely to correspond to services providers may include all party identifiers corresponding to a particular category. The system may further comprise a learning engine executable by the at least one processor, the learning engine for obtaining crowd-sourced data to identify party identifiers that are unlikely to correspond to service providers. The system may further comprise a learning engine executable by the at least one processor, the learning engine for obtaining crowd-sourced data to associate party identifiers to more common company names, so that users can more easily identify the likely service providers. The system may further comprise a learning engine executable by the at least one processor, the learning engine for obtaining crowd-sourced data to identify party identifiers of parties users have identified as service providers.

In some embodiments, a method comprises receiving a request to determine potential service provider accounts that a user has with one or more service providers; obtaining financial data records of the user from an application programming interface that obtains the financial data records of the user from a financial provider system, each respective financial data record corresponding to a respective transaction and including a respective date, a respective amount, and a respective party identifier corresponding to a respective party associated with the respective transaction; evaluating the financial data records to generate at least one confidence score corresponding to at least one party, the confidence score indicating the likelihood that the user has a service provider account with the party; and identifying the potential service provider account based on the at least one confidence score.

Each confidence score may be based on gaps between transactions and variance in transaction amounts. The financial data records of the user may include at least three months of financial data records of the user. The method may further comprise identifying party identifiers who are highly unlikely to correspond to service providers. Each financial data record may further include a category. The party identifiers who are unlikely to correspond to services providers may include all party identifiers corresponding to a particular category. The method may further comprise obtaining crowd-sourced data to identify party identifiers that are unlikely to correspond to service providers. The method may further comprise obtaining crowd-sourced data to associate party identifiers to more common company names, so that users can more easily identify the likely service providers. The method may further comprise obtaining crowd-sourced data to identify party identifiers of parties users have identified as service providers.

In some embodiments, a system comprises means for receiving a request to determine potential service provider accounts that a user has with one or more service providers; means for obtaining financial data records of the user from an application programming interface that obtains the financial data records of the user from a financial provider system, each respective financial data record corresponding to a respective transaction and including a respective date, a respective amount, and a respective party identifier corresponding to a respective party associated with the respective transaction; means for evaluating the financial data records to generate at least one confidence score corresponding to at least one party, the confidence score indicating the likelihood that the user has a service provider account with the party; and means for identifying the potential service provider account based on the at least one confidence score.

### BRIEF DESCRIPTION OF THE DRAWINGS

FIG. 1 is a block diagram of an estate data network system, according to some embodiments.

FIG. 2 depicts an example client system, according to some embodiments.

FIG. 3 depicts an example estate data server system, according to some embodiments.

FIG. 4 depicts an example financial data gathering system, according to some embodiments.

FIG. 5 depicts an example estate account discovery system, according to some embodiments.

FIG. 6 depicts an example administrator system, according to some embodiments.

FIG. 7 is a flowchart of an example of a method for determining estate accounts using a financial account of an estate, according to some embodiments.

FIG. 8 is a flowchart of an example of a method for determining potential estate accounts from financial data, according to some embodiments.

FIG. 9 is a flowchart of an example of a method for determining an estate account confidence score for an account, according to some embodiments.

FIG. 10 is a flowchart of an example of a method for managing learning for improving estate account detection using curation input, according to some embodiments.

FIG. 11 is a screenshot of an example interface for managing discovered estate accounts, according to some embodiments.

FIG. 12 is a screenshot of an example interface for inputting financial account login information, according to some embodiments.

FIG. 13 is a screenshot of an example interface illustrating the discovering of potential estate accounts, according to some embodiments.

FIG. 14 is a screenshot of an example interface for displaying a number of discovered estate accounts to an estate user, according to some embodiments.

FIG. 15 is a screenshot of an example interface for allowing a user to interact with the system in curating the potential estate accounts, according to some embodiments.

FIG. 16 is a screenshot of an example interface for allowing a user to view accounts with service providers within a service provider type, according to some embodiments.

FIG. 17 is a screenshot of an example interface through which an estate user can choose service providers with which to manually enter or edit estate accounts, according to some embodiments.

FIG. 18 is a screenshot of an example interface through which an estate user can manually enter or edit estate account data for an estate account, according to some embodiments.

### DETAILED DESCRIPTION

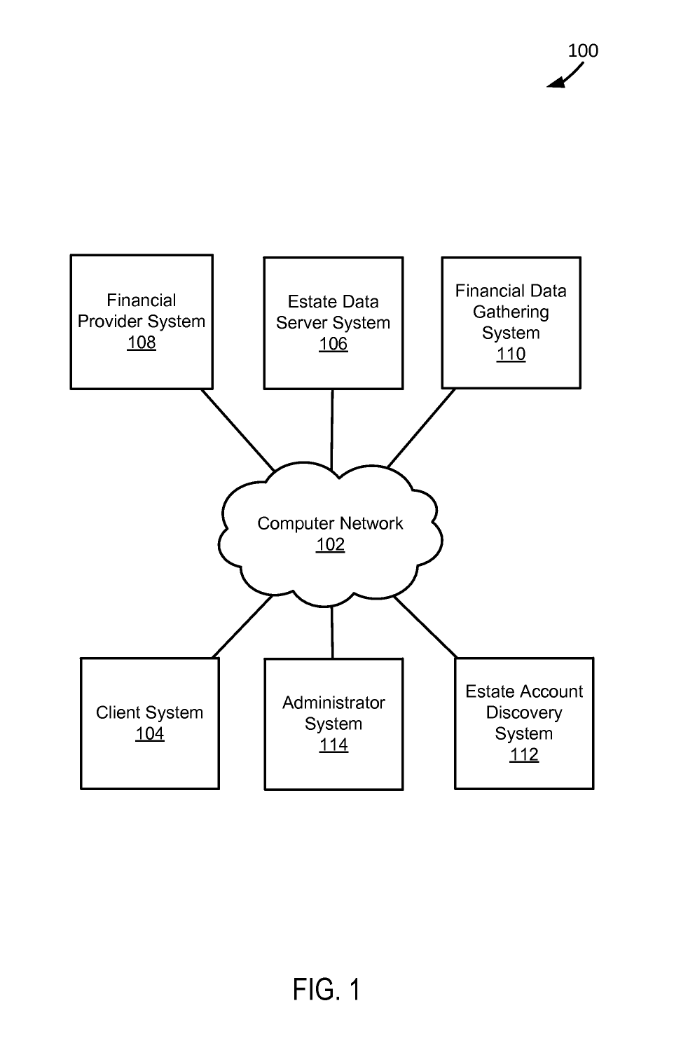

FIG. 1 is a block diagram of an estate data network system 100, according to some embodiments. The estate data network system 100 shown in FIG. 1 includes a client system 104, an estate data server system 106, a financial provider system 108, a financial data gathering system 110, an estate account discovery system 112, and an administrator system 114, each coupled together via a computer network 102.

The computer network 102 functions to transmit data between the client system 104, the estate data server system 106, the financial provider system 108, the financial data gathering system 110, the estate data server system 112, and the administrator system 114. The computer network 102 may include a medium that couples digital devices to one another. The computer network 102 may include technologies such as Ethernet, 802.11x, worldwide interoperability for microwave access WiMAX, 2G, 3G, 4G, CDMA, GSM, LTE, digital subscriber line (DSL), and/or the like. The computer network 102 may further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and/or the like. Data exchanged over the computer network 102 may be represented using technologies and/or formats including hypertext markup language (HTML) and extensible markup language (XML). In addition, all or some links may be encrypted using conventional encryption technologies such as secure sockets layer (SSL), transport layer security (TLS), and Internet Protocol security (IPsec). Though element 102 is labeled a “computer network”, it is noted that in various embodiments, the element 102 may refer to any medium that facilitates communication among digital devices, or among components of digital devices. In various embodiments, the element 102 may refer to a bus, cable, or other communication device.

The client system 104 functions to send and receive data used in interacting with the estate data server system 106. The data may be data used in the management of an estate, including accounts of the estate, financial account login information, and the like. In various embodiments, the client system 104 may be utilized, by an estate user. An estate user may include either or both an owner of an estate and a person with the power to manage the estate and/or instruct the closure of estate accounts. Estate accounts may include service accounts. For example, estate accounts may include accounts with utility providers, or financial accounts, e.g. bank or credit card accounts. Using the client system 104, the estate user may provide financial account login information, e.g., a username and a password, to provide access to a financial account of the estate owner.

The client system 104 may be utilized, by an estate user, to send to the estate data server system 106 account discovery instructions to begin discovering estate accounts of an estate using financial account login information. In various embodiments, account discovery instructions can include an identification of an estate owner and/or identification of a financial account from which to gather financial data using the financial account login information.

The client system 104 may reside on a digital device such as a mobile phone, a Personal Data Assistant (PDA), a tablet computing device, a laptop computer, a desktop computer, a thin client, an ultra-thin client or some combination thereof. A digital device may include a processor and a network interface. The processor may include a shared or dedicated processor configured to execute instructions loaded in a memory of the client system 104. The processor may include a general purpose processor that executes an operating system, processes, and applications loaded into the memory of the client system 104. The processor may provide instructions to execute a network interface of the client system 104. The network interface may include hardware, firmware, and/or software configured to receive data from the computer network 102 and provide data to the computer network 102. The network interface may be compatible with the transmission protocols of the computer network 102 and other portions of the client system 104. The network interface may include a wireless interface through which the client system 104 may wirelessly send and receive data.

The estate data server system 106 functions to send and receive data used in interacting with the client system 104. Data sent and received by the estate data server system 106 may be used in the management of an estate, including accounts of the estate. In various embodiments, the estate data server system 106 may receive financial account login information and/or account discovery instructions from the client system 104. In response to receiving account discovery instructions, the estate data server system 106 may instruct the financial data gathering system 110 to gather financial data for an estate from a financial account included as an estate account for the estate. Additionally, in response to receiving account discovery instructions, the estate data server system 106 may send to the financial data gathering system 110 financial account login information used to access a financial account and gather financial data for the financial account. Further in response to receiving account discovery instructions, the estate data server system 106 may send to the financial data gathering system 110 identification of an estate owner and/or identification of a financial account to gather financial data from using financial account login information.

The financial provider system 108 operates to provide the financial services of a financial provider to an estate owner. A financial provider may provide financial services related to a financial account included as an estate account of an estate. For example, if a financial provider is a credit provider providing a credit account, then the financial provider may provide financial services related to providing credit transactions. The financial provider system 108 may maintain financial data, e.g., financial data records, related to financial transactions provided by the financial provider. Financial data maintained by the financial provider system 108 may include data describing financial transactions, including parties involved in transactions, dates when the transactions occurred, amounts of money involved in the transactions, and/or information describing the transactions (e.g., categories or tags). In maintaining financial data related to financial transactions, the financial provider system 108 may update the financial data as transactions continue to occur. The financial provider system 108 may enable access to the financial data maintained by the financial provider system 108 for a financial account using financial account login information for the financial account.

The financial data gathering system 110 functions to collect financial data used in discovering estate accounts of an estate from the financial provider system 108. The financial data gathering system 110 may provide gathered financial data to the estate account discovery system 112 described herein. The financial data gathering system 110 may collect financial data from the financial provider system 108 after receiving instructions to collect the financial data. The financial data gathering system 110 can be set to collect automatically updated financial data from the financial provider system 108, e.g., after a set period of time, e.g. a month, has passed since the financial data gathering system 110 last collected financial data from the financial provider system 108. In various embodiments, the financial data gathering system 110 may gather a set time period of transactions, e.g., the last three months or the last three years of financial data records.

In various embodiments, the financial data gathering system 110 uses the financial account login information received from the estate data server system 106 to gain access to a financial account and gather financial data for the financial account. The financial data gathering system 110 may use either or both identification of the estate owner and/an identification of a financial account along with financial account login information to gain access to the financial data records of a financial account. The financial data gathering system 110 may include an applicable application programming interface (hereinafter referred to as “API”), such as the Intuit® API, to login to the financial provider system 108 using the financial account login information. In various embodiments, the financial data gathering system 110 collects the financial data for a financial account.

In various embodiments, the financial data gathering system 110 may collect financial data from a plurality of financial accounts from one or more financial provider systems 108. The financial data gathering system 110 may collect financial data from a plurality of financial accounts of a single financial provider. For example, the financial data gathering system 110 can collect financial data from a first credit account and a second credit account that an estate owner has with one or two credit providers.

In various embodiments, the estate account discovery system 112 functions to discover potential estate accounts from financial data collected by the financial data gathering system 110. The estate account discovery system 112 may determine potential estate accounts from transactions between parties included as part of the financial data. In determining potential estate accounts based on transactions, the estate account discovery system 112 may group transactions according to payee name on the transactions, patterns of transactions, and/or amounts of money exchanged in each transaction. In various embodiments, the estate account discovery system 112 may group and/or reject transactions as associated with a potential estate account based on whether parties in the transactions appear on a whitelist and/or a blacklist.

In various embodiments, the estate account discovery system 112 functions to assign, increase, decrease, and/or otherwise affect an estate account confidence score for accounts. The estate account discovery system 112 may assign, increase, decrease, and/or otherwise affect an estate account confidence score for an account based on dates of transactions, a frequency of transactions, gaps between transactions, transaction amounts of transactions, and/or variances in transaction amounts of transactions. The estate account discovery system 112 may use an estate account confidence score of an account, to determine if the account is a potential estate account. In various embodiments, the estate account discovery system 112 may determine an account is a potential estate account if an estate account confidence score of the account is greater than a threshold score.

The administrator system 114 functions to enable an administrator to manage the discovery networks system 100. The administrator system 114 may enable an administrator to set thresholds, e.g., confidence score thresholds, transaction amount thresholds, gap thresholds, transaction amount variance thresholds, etc. that the estate account discovery system 112 uses in determining an account from financial data. The administrator system 114 may enable an administrator to add parties to blacklisted parties who are excluded from providing estate accounts, or whitelisted parties who are automatically identified as providing estate accounts. Further, the administrator system 114 may enable an administrator to add, modify, and/or change rules that the estate account discovery system 112 uses in assigning an estate account confidence score to discovered accounts. The administrator system 114 may enable an administrator to modify the system 100 in other ways.

In various embodiments, the estate account discovery system 112 functions to manage learning used to improve the identification of potential estate accounts and/or the determining, increasing, decreasing and/or otherwise affecting of an estate account confidence score for an account. The estate account discovery system 112 may use user curation input, crowd-sourced data, and/or administrator input to manage learning. Curation input includes input received from an estate user in response to being presented with potential estate accounts. For example, curation input may include whether a potential estate account is in fact an estate account, categories of service provider to which parties in a potential estate account belong, and/or actual names of parties included in a potential estate account. In various embodiments, in managing learning, the estate account discovery system 112 may add or remove parties from a whitelist and/or a blacklist, set thresholds for discovering and/or determining, increasing, decreasing and/or otherwise affecting of an estate account confidence score for an account, and/or manage party mapping data used to map transactions in financial data to specific parties.

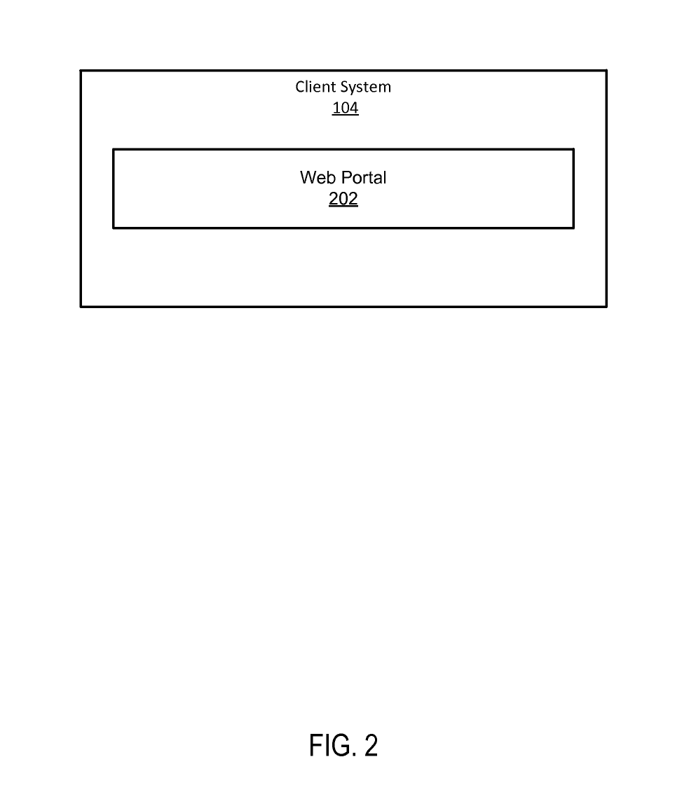

FIG. 2 depicts an example client system 104, according to some embodiments. The example client system 104 includes a web portal 202. The web portal 202 may receive web page information from the estate data server system 106 to manage financial account login information. The web portal 202 may receive, from an estate user, financial account login information, which the web portal 202 sends to the estate data server system 106. The web portal 202 may send the financial account login information immediately after it is input by an estate user, after a specific amount of time, and/or after the occurrence of a specific event. For example, the web portal 202 may send the financial account login information after the estate owner dies.

The web portal 202 may receive web page information from the estate data server system 106 to manage account discovery instructions. The web portal 202 may generate and send account discovery instructions according to input received from an estate user to the estate data server system 106. The web portal 202 may generate and send account discovery instructions, according to input from an estate user indicating to begin discovery of estate accounts using collected financial data. Further, the web portal 202 may generate and send user curation input according to input from an estate user made during curation of discovered estate accounts.

The web portal 202 may receive web page information from the estate data server system 106 to manage receipt of estate data. Estate data may include one or more of an identification of a discovered account, one or more transactions used in discovering the account, parties involved, an estate account confidence score for the discovered account, an amount of money transferred in the one or more transactions, and dates when the transactions occurred.

The web portal 202 may receive web page information from the estate data server system 106 to manage curation by an estate user of discovered accounts. An estate user may review discovered accounts and indicate, as part of curation input, whether the accounts are indeed estate accounts for the estate. Additionally, an estate user may indicate, as part of curation input, the common name of a service provider associated with an account, an identification of a service provider in financial data, and/or a category of service provided by the service provider.

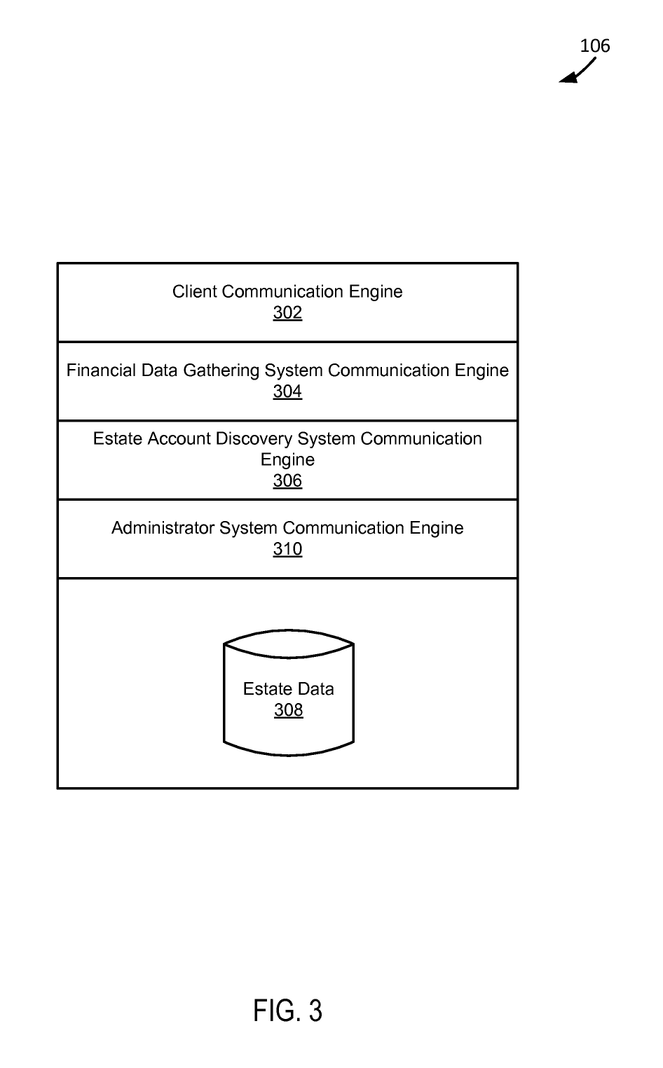

FIG. 3 depicts an example estate data server system 106, according to some embodiments. The example estate data server system 106 includes a client communication engine 302, a financial data gathering system communication engine 304, an estate account discovery system communication engine 306, an estate data store 308, and an administrator system communication engine 310.

The client communication engine 302 functions to manage communication between the estate data server system 106 and the client system 104. The client communication engine 302 may receive account discovery instructions and financial account login information from the client system 104. Further, the client communication engine 302 may send estate data, as determined by either or both the financial data gathering system 110 and the estate account discovery system 112, to the client system 104.

The financial data gathering system communication engine 304 functions to manage communication between the estate data server system 106 and the financial data gathering system 110. The financial data gathering system communication engine 304 may send financial account login information received from the client system 104 to the financial data gathering system 110. Further, the financial data gathering system communication engine 304 may receive financial data collected by the financial data gathering system 110. The financial data gathering system communication engine 306 may store the financial data, included as part of estate data, at the estate data server system 106 in the estate data store 308. In some embodiments, the financial data gathering system communication engine 304 may instruct the financial data gathering system 110 to send the financial data directly to the estate account discovery system 112.

The estate account discovery system communication engine 306 functions to manage communication between the estate data server system 106 and the estate account discovery system 112. The estate account discovery system communication engine 306 may send financial data collected by the financial data gathering system 110 to the estate account discovery system 112. Further, the estate account discovery system communication engine 306 may receive estate data from the estate account discovery system 112. The estate account discovery system communication engine 306 may store the estate data received from the estate account discovery system 112 at the estate data server system 106 in the estate data store 308. In various embodiments, the estate account discovery system communication engine 306 may send input received from an administrator, through the administrator system 114, to the estate account discovery system 112. For example, the estate account discovery system communication engine 308 may send input from an administrator including one or more of a transaction frequency threshold, a transaction amount threshold, a transaction amount variance threshold, blacklisted parties and/or whitelisted parties.

The administrator system communication engine 310 functions to manage communication between the estate data server system 106 and the administrator system 114. The administrator system communication engine 310 may receive input from the administrator system 114 regarding discovering estate accounts in financial data. In various embodiments, the administrator communication engine 310 may receive input from the administrator system 114 regarding one or more thresholds, e.g., a confidence score threshold, a transaction frequency threshold, a transaction amount threshold, a transaction amount variance threshold, blacklisted parties and/or whitelisted parties.

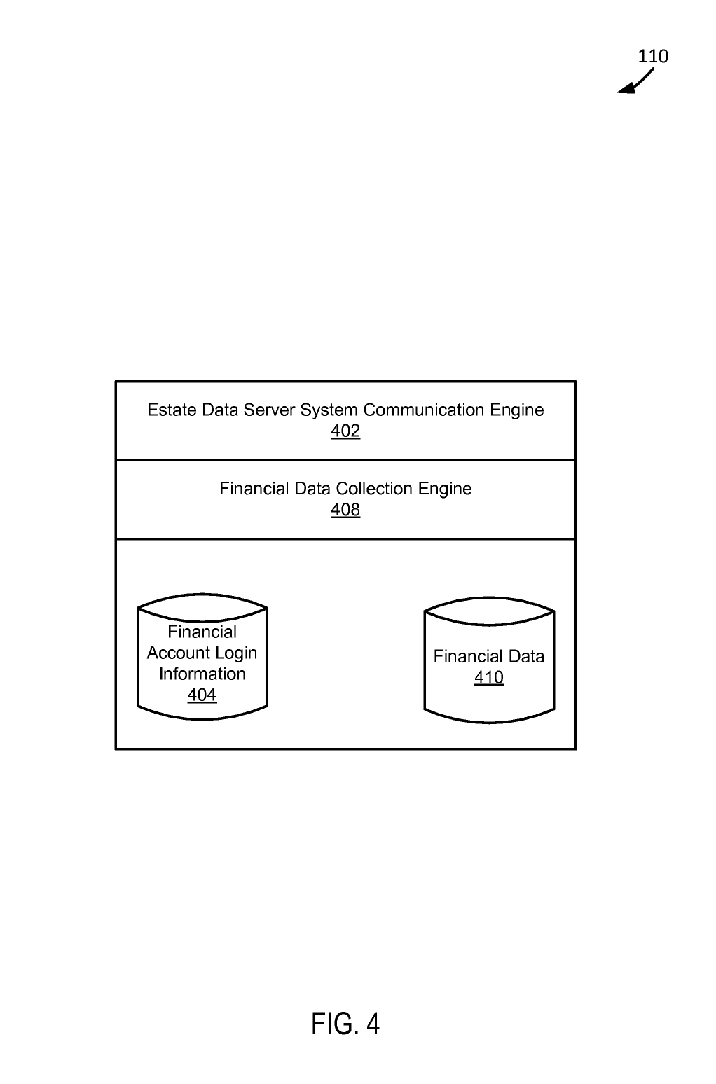

FIG. 4 depicts an example financial data gathering system 110, according to some embodiments. The example financial data gathering system 110 includes an estate data server system communication engine 402, a financial account login information store 404, a financial data collection engine 408, and a financial data store 410. The estate data server system communication engine 402 functions to manage communication between the estate data server system 106 and the financial data gathering system 110. The estate data server system communication engine 402 may receive financial account login information from the estate data server system 106. Received financial account login information may be stored by the estate data server system communication engine 402 at the financial data gathering system 110 in the financial account login information store 404. The estate data server system communication engine 402 may receive account discovery instructions from the estate data server system 106. The estate data server system communication engine 402 may be used to send collected financial data to the estate data server system 106.

The financial data collection engine 408 functions to collect financial data for a financial account. The financial data collection engine 408 may gain access to an account through a financial provider system 108 by logging in using the financial account login information stored in the financial account login information store 404. The financial data collection engine 408 may access a financial provider system 108 using an applicable API, such as the Intuit® Customer Account Data API. Financial data collected by the financial data collection engine 408 may be stored in the financial data store 410.

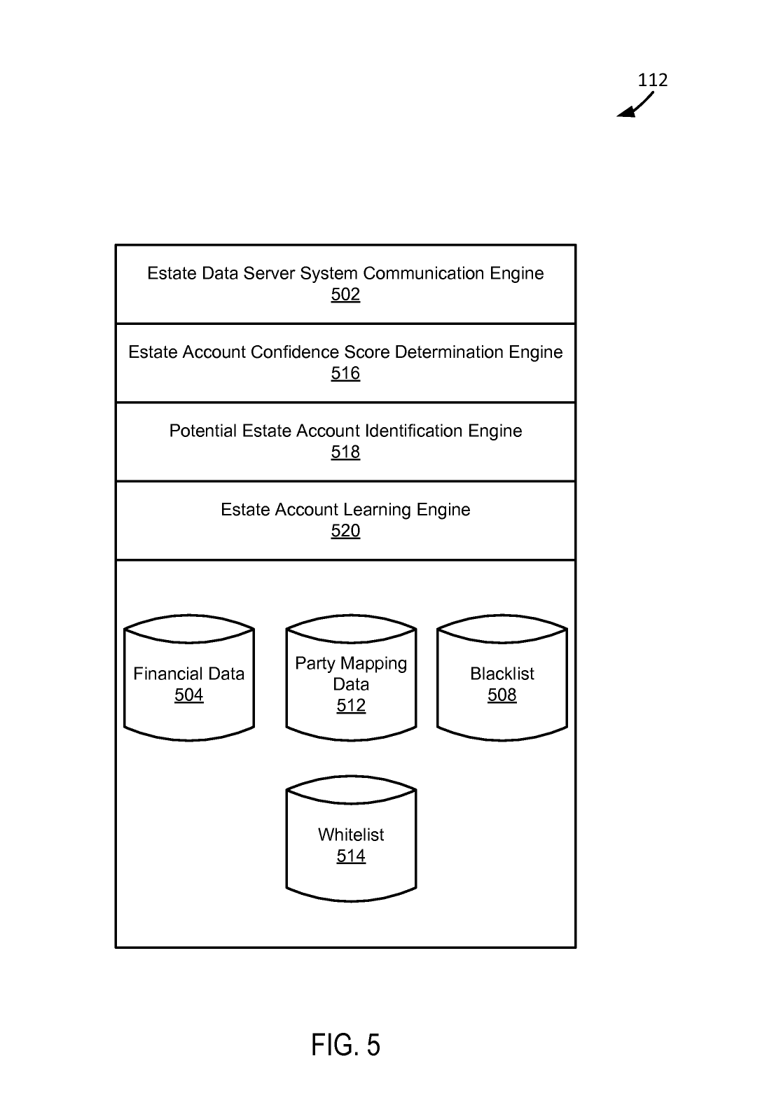

FIG. 5 depicts an example estate account discovery system 112, according to some embodiments. The example estate account discovery system 112 includes an estate data server system communication engine 502, a financial data store 504, a blacklist store 508, a party mapping data store 512, a whitelist store 514, an estate account confidence score determination engine 512, a potential estate account identification engine 518, and an estate account learning engine 520.

The estate data server system communication engine 502 functions to manage communication between the estate data server system 106 and the estate account discovery system 112. The estate data server system communication engine 502 may receive financial data from the estate data server system 106 that is collected by the financial data gathering system 110 or directly from the financial data gathering system 110. The estate data server system communication engine 502 may store the received financial data at the estate account discovery system 112 in the financial data store 504. The estate data server system communication engine 502 may receive account discovery instructions from the estate data server system 106. The estate data server system communication engine 502 may receive user curation input indicating whether discovered accounts are actually estate accounts. The estate data server system communication engine 502 may receive input from an administrator. For example, the estate data server system communication engine 502 may receive input from an administrator indicating one or more of a confidence score threshold, a transaction frequency threshold, a transaction amount threshold, a transaction amount variance threshold, blacklisted parties and/or whitelisted parties. The estate data server system communication engine 502 may send estate data, including estate data related to potential estate accounts, to the estate data server system 106.

The estate account confidence score determination engine 516 functions to determine potential estate accounts and determine, increase, decrease and/or otherwise affect an estate account confidence score for potential estate accounts from collected financial data. The estate account confidence score determination engine 516 can determine potential estate accounts based on transactions between parties included as part of the financial data. In various embodiments, the estate account confidence score determination engine 516 may look for expected payment characteristics of estate accounts, which for example might include payments of approximately the same amount paid with a generally consistent recurring pattern (e.g., monthly, yearly, etc.). Accordingly, in some embodiments, the estate account confidence score determination engine 516 may evaluate the time gaps between transactions and amounts of each transaction to help identify estate accounts of the estate owner. In various embodiments, the estate account confidence score determination engine 516 may determine potential estate accounts according to a blacklist, included as part of blacklist data stored in the blacklist store 508.

In some embodiments, the estate account confidence score determination engine 516 may first go through each account indicated by transactions in the financial data, and look for a category of the account. The estate account confidence score determination engine 516 may then query a mapping database to see if that category matches a whitelisted or blacklisted category. If it does, then the estate account confidence score determination engine 516 can store account information of the account for that category within the category in the mapping database. If it does not, then the estate account confidence score determination engine 516 may record the category for future mapping.

In various embodiments, after discovering the accounts, the estate account confidence score determination engine 516 searches for providers. The estate account confidence score determination engine 516 groups the transactions by the payee name on the transaction report included as part of the financial data. After grouping the transactions, the estate account confidence score determination engine 516 rejects all transactions under $5. The estate account confidence score determination engine 516 reviews the transactions to determine if the transactions for the payee have a pattern. For each transaction, the estate account confidence score determination engine 516 records the posted date and the amount. The estate account confidence score determination engine 516 removes a group of transactions that has less than a predetermined number of transactions. For example, if the period of transactions is three months, then the estate account confidence score determination engine 516 may reject a group of transactions with less than three transactions. The estate account confidence score determination engine 516 may create a weighted sum in determining potential estate accounts. A first weighted item may include the likelihood that the dates are in a pattern. The estate account confidence score determination engine 516 may determine this by looking at the gap between each transaction, taking the standard deviation of that group and dividing it by the mean of the group. A second weighted item may include the likelihood of the amounts being in a pattern using a relative standard deviation. A third weighted item may include the inverse log of the mean of the amounts, meaning that larger transactions will have a lower score. A fourth weighted item may include a simple check whether the amounts are over a certain barrier ($50) or the date matching is perfect (i.e., the transaction occurs exactly every day). Another weighted item may be the number of transactions. Typical accounts have a small number of transactions in a three-month period. The estate account confidence score determination engine 516 may generate a weighted sum based on the previously described weighted items for comparison to a threshold. The threshold may be determined by comparing the discovery of potential estate accounts against real transactional data. If the weighted sum is greater than the threshold, then the payee name and other transactional information may be used to add a potential estate account for the estate owner.

In various embodiments, the estate account confidence score determination engine 516 may discover potential estate accounts by using existing data to find the accounts. The estate account confidence score determination engine 516 may parse through a list of transactions, to see if a transaction category matches a category which it is determined to automatically match. If true, then the estate account confidence score determination engine 516 can locate a mapped provider or create a temporary provider for the user. In various embodiments, accounts discovered using a weight sum are not limited to auto matching categories. In various embodiments, any item that was discovering in the pattern matching process will be added no matter what. In various embodiments the estate account confidence score determination engine 516 can map using 4 separate tables. One table can be for internal categories, one table can be for Intuit® categories, one table can be for internal providers, and one table can be for Intuit® providers. An administrator can determine if certain Intuit® categories should automatically map to internal categories and similarly with providers.

In determining, increasing, decreasing and/or otherwise affecting an estate account confidence score for potential estate accounts, the estate account confidence score determination engine 516 may group transactions together according to the parties involved in the transaction. For example, if a payee is common across a plurality of transactions, then the estate account confidence score determination engine 516 may group the plurality of transactions together. In various embodiments, the estate account confidence score determination engine 516 may determine potential estate accounts according to a blacklist. A blacklist may identify parties for which transactions are assumed not part of an estate account. In determining potential estate accounts according to a blacklist, the estate account confidence score determination engine 516 may remove transactions from the financial data that involve any of the parties in the blacklist.

The estate account confidence score determination engine 516 may determine, increase, decrease and/or otherwise affect an estate account confidence score based, at least in part, on dates of transactions, a frequency of transactions, or gaps between transactions. In various embodiments, the estate account confidence score determination engine 516 may determine, increase, decrease and/or otherwise affect an estate account confidence score based on whether a number of transactions made with a party in a specific amount of time exceed a transaction frequency threshold. For example, the estate account confidence score determination engine 516 may increase a confidence score of an account if a payment transaction recurs every month with a particular party. Notably, the confidence score can be a percentage confidence score, e.g., a number between 1 and 100.

The estate account confidence score determination engine 516 may determine, increase, decrease and/or otherwise affect an estate account confidence score based, at least in part, on transaction amounts of transactions. The estate account confidence score determination engine 516 may determine, increase, decrease and/or otherwise affect an estate account confidence score based on whether a transaction amount for a transaction with the parties is greater than a transaction amount threshold. For example, if a transaction amount for a transaction is for less than five dollars, then the estate account confidence score determination engine 516 may lower the confidence score of an account including the transaction.

The estate account confidence score determination engine 516 may determine, increase, decrease and/or otherwise affect an estate account confidence score based, at least in part, on variances in transaction amounts of financial transaction. The estate account confidence score determination engine 516 may determine, increase, decrease and/or otherwise affect an estate account confidence score based on whether variances in transaction amounts are less than a transaction amount variance threshold for determining an estate account. For example, if a variance in transaction amounts of transactions for an account does not differ by a certain dollar amount or is within a certain percentage different each month of each other, then the estate account confidence score determination engine 516 may determine, increase, decrease and/or otherwise affect an estate account confidence score.

The estate account confidence score determination engine 516 may determine, increase, decrease and/or otherwise affect an estate account confidence score based, at least in part, on whether parties in transactions for the account appear on a whitelist. For example, if the estate account confidence score determination engine 516 determines that the party is on the whitelist, as indicated by whitelist data in the whitelist store 514, then the estate account confidence score determination engine 516 may determine, increase, decrease and/or otherwise affect the estate account confidence score.

The estate account confidence score determination engine 516 may determine, increase, decrease and/or otherwise affect an estate account confidence score for an account according an applicable combination of the previously described factors. Specifically, the estate account confidence score determination engine 516 may determine an estate account confidence score for an account based on the amount of transactions used to determine the account, gaps between the transactions, variances in amounts of the transactions, and whether the party to the transaction is on a whitelist or a blacklist.

The potential estate account identification engine 518 can determine potential estate accounts. The potential estate account identification engine 518 can determine potential estate accounts based on estate account confidence scores given to accounts by the estate account confidence score determination engine 516. In various embodiments, the potential estate account identification engine 518 can determine accounts are potential estate accounts if an estate confidence score for the accounts exceeds a threshold confidence score level. For example, if a threshold confidence score level is 80% and an estate account confidence score of an account is 90%, then the potential estate account identification engine 518 can identify the account as a potential estate account.

The estate account learning engine 520 functions to manage learning used to improve the identification of potential estate accounts and/or the determining, increasing, decreasing and/or otherwise affecting of an estate account confidence score by the estate account confidence score determination engine 516. In managing learning, the estate account learning engine 520 may function to learn from user curation input, crowd-sourced data, and/or administrator input. If one or more users identify a previously missed party as a service provider or identify a false positive party as not a service provider, then the estate account learning engine 520 may add the party or category to a blacklist or a whitelist or remove a party or category from a blacklist, indicated by blacklist data stored in the blacklist store 508, or a whitelist, indicated by whitelist data stored in the whitelist store 514. The estate account learning engine 520 may determine that adding the party or category to or subtracting the party or category from a blacklist or whitelist would have caused the estate account confidence score determination engine 516 to resolve potential estate accounts in line with the curation input, crowd-sourced data, and/or administrator input.

The estate account learning engine 520 may also function to use user curation input, crowd-sourced data, and/or administrator input to set thresholds, e.g., confidence score thresholds, transaction amount thresholds, gap thresholds, transaction amount variance thresholds, etc. that the estate account confidence score determination engine 516 uses in determining an account from financial data and/or determining, increasing, decreasing and/or otherwise affecting an estate account confidence score. The estate account learning engine 520 may determine that modification of various thresholds would have caused the estate account confidence score determination engine 516 to resolve potential estate accounts in line with the user curation input and/or crowd-sourced data.

The estate account learning engine 520 may also function to manage party mapping data, stored in the party mapping data store 512, to improve the identification of potential estate accounts. The estate account learning engine 520 may use user curation input, crowd-sourced data, and/or administrator input to manage party mapping data. Party mapping data may include data used to map financial data for transactions to specific parties. For example, party mapping data may include the common name of a service provider as compared to the identifier used in financial data to represent the party. For example, if PG&E is represented as “Pgandeweb” in financial data for transactions, then the party mapping data can indicate that “Pgandeweb” represents PG&E. If one or more users edit a party identifier in the financial records to a more common party name, the estate account confidence score determination engine 516 may learn to refer to the party by the more common party name (instead of by the uncommon party identifier). The estate account learning engine 520 may use the more common name of “PG&E” so that users do not inadvertently remove the unknown entity “Pgandeweb” from the list of service provider accounts.

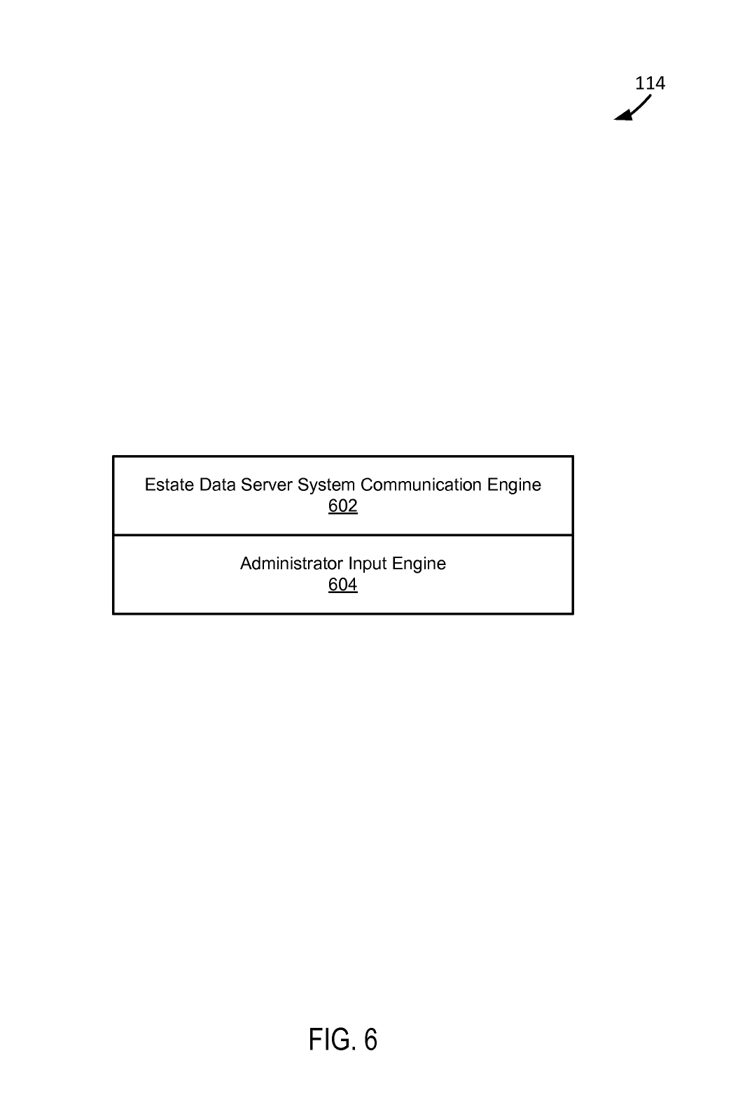

FIG. 6 depicts an example administrator system 114, according to some embodiments. The example administrator system 114 includes an estate data server communication engine 602, and an administrator input engine 604.

The estate data server system communication engine 602 functions to manage communication between the estate data server system 106 and the administrator system 114. The administrator input engine 604 functions to manage input from an administrator. For example, the administrator input engine 604 may receive one or more of a confidence score threshold, a transaction frequency threshold, a transaction amount threshold, a transaction amount variance threshold, and whitelisted and blacklisted parties. The estate data server system communication engine 602 may send the input received from an administrator to the estate data server system 106.

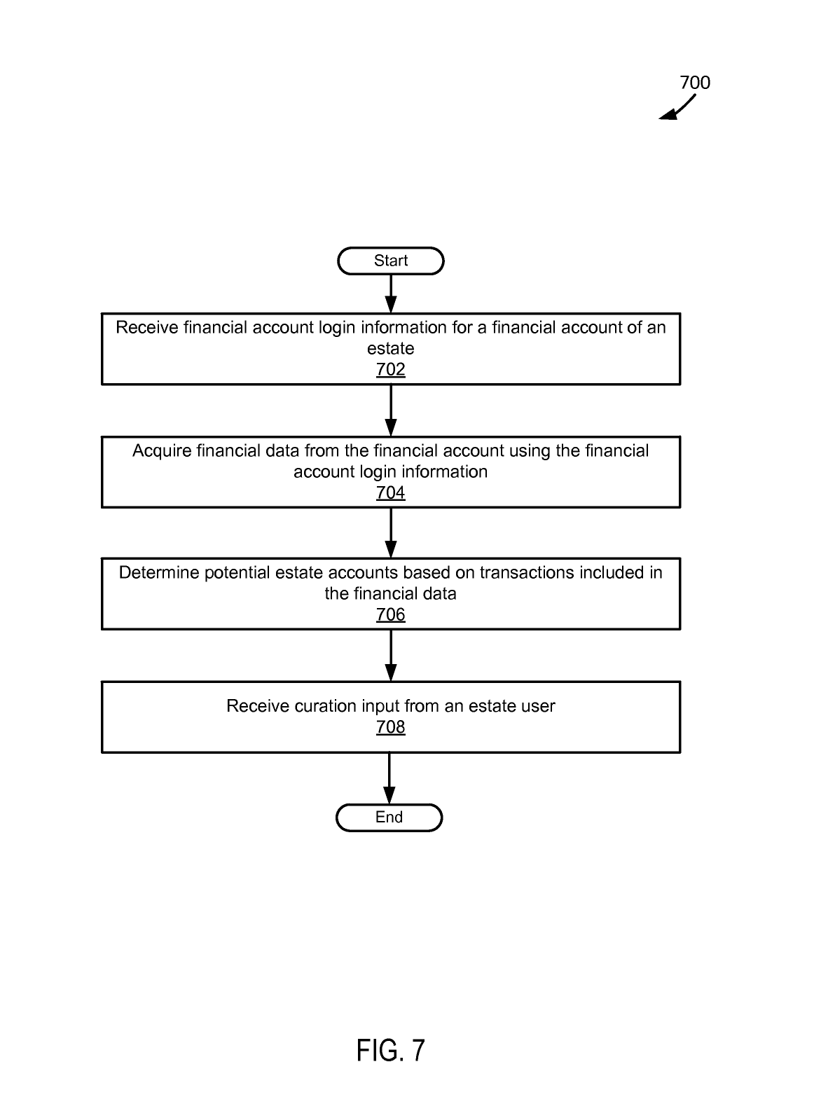

FIG. 7 is a flowchart of an example of a method 700 for determining estate accounts using a financial account of an estate. It is noted the steps in FIG. 7 are by way of illustration only, and that the method 700 may include elements not explicitly depicted, and that all elements are not necessary to perform the method 700.

At step 702, financial account login information is received for a financial account of an estate. A financial account of an estate can be a financial account of an estate owner. The financial account login information can include a username and a password used to access a financial account through a financial provider system that provides the financial account. The financial account login information can be received by a client communication engine at an estate data server system from a web portal included as part of a client system.

At step 704, financial data from the financial account is acquired using the financial account login information. The financial data can be acquired by a financial data collection engine included as part of a financial data gathering system. The financial data can be acquired from a financial provider system. The financial provider system can be accessed through an applicable API, such as the Intuit® API, using the financial account login information.

At step 706, potential estate accounts are determined based on transaction included in the financial data. The potential estate accounts can be determined from the financial data by an estate account discovery system. Transactions that involve parties on a blacklist can be removed from the financial data. An estate account confidence score may be assigned, increased, decreased, and/or otherwise affected for the accounts indicated by the transactions. In various embodiments, the estate account confidence score can be assigned, increased, decreased, and/or otherwise affected based on the amounts of the transactions, variances in the amounts of the transactions, gaps between the transactions, frequency of the transactions, whitelists, and/or blacklists. Potential estate accounts can be determined based on estate account confidence scores.

At step 708, curation input is received from an estate user. The curation input can be used to determine whether potential estate accounts are estate accounts.

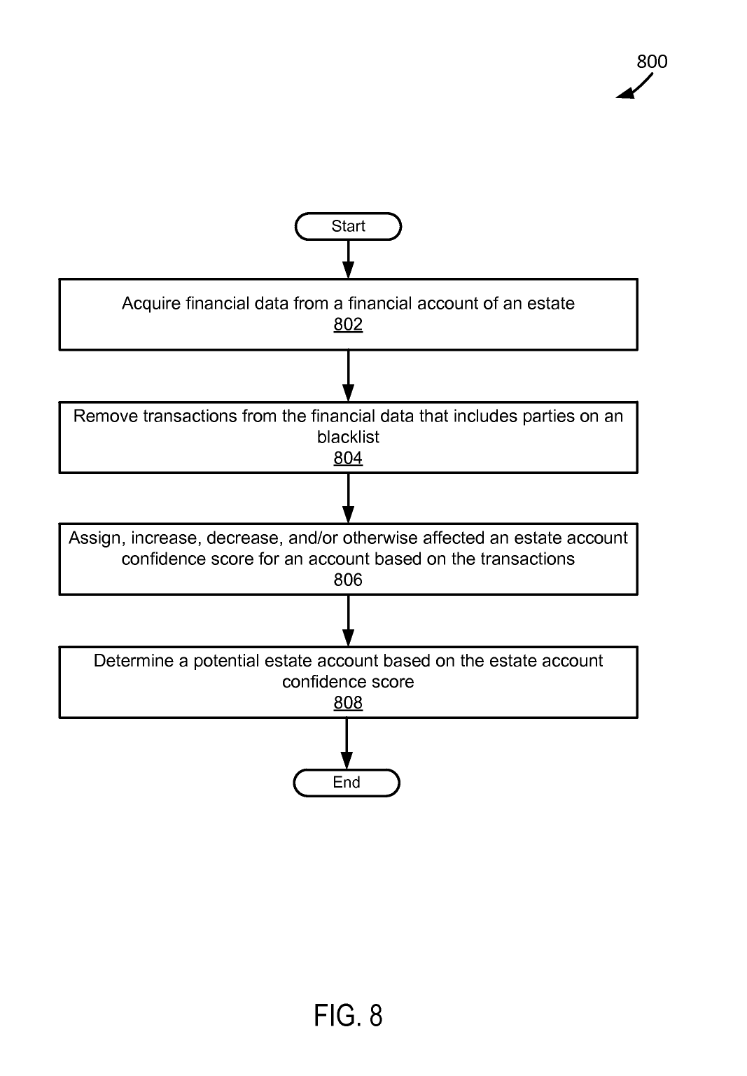

FIG. 8 is a flowchart of an example of a method 800 for determining potential estate accounts from financial data. It is noted the steps in FIG. 8 are by way of illustration only, and that the method 800 may include elements not explicitly depicted, and that all elements are not necessary to perform the method 800.

At step 802, financial data from a financial account of an estate is acquired. Financial data from the financial account of the estate can be collected by a financial data gathering system from a financial provider system 108.

At step 804, transactions from the financial data that involve parties on a blacklist can be removed from the financial data. The blacklisted transactions can be removed from the financial data by an estate account confidence score determination engine.

At step 806, an estate account confidence score is assigned, increased, decreased, and/or otherwise affected for an account based on the transactions, e.g., based on the amounts of the transactions, variances in the amounts of the transactions, gaps between the transactions, frequency of the transactions, whitelists, and/or blacklists. The estate account confidence score can be assigned, increased, decreased, and/or otherwise affected by an estate account confidence score determination engine.

At step 808, a potential estate account is determined based on the estate account confidence score. A potential estate account identification engine can determine if an account is a potential estate account based on the estate account confidence score for the account. In various embodiments, accounts can be determined to be potential estate accounts if an estate confidence score for the accounts exceeds a threshold confidence score level.

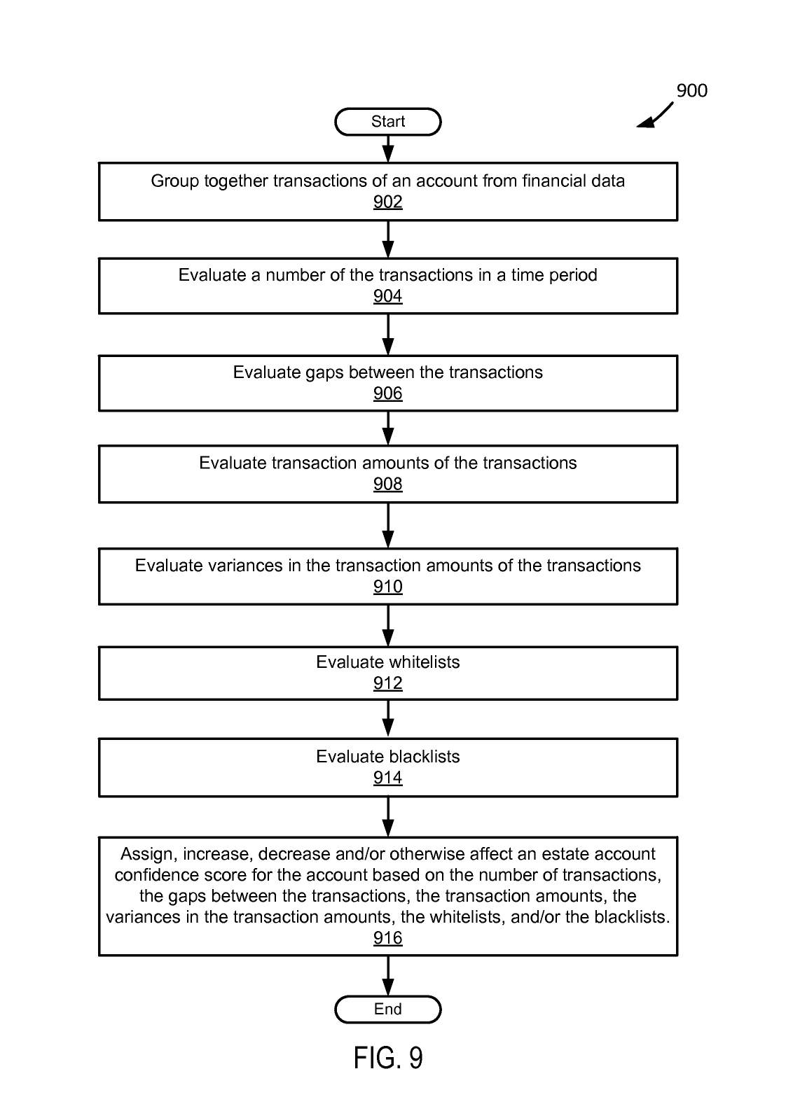

FIG. 9 is a flowchart of an example of a method 900 for determining an estate account confidence score for an account. It is noted the steps in FIG. 9 are by way of illustration only, and that the method 900 may include elements not explicitly depicted, and that all elements are not necessary to perform the method 900.

At step 902, transactions of an account are grouped together from financial data, e.g., based on parties of the transactions. Transactions of the account can be grouped together by an estate account discovery system.

At step 904, a number of the transactions grouped together in a time period are evaluated. An estate account confidence score determination engine can determine the number of the transactions grouped together. For example, is some embodiments, if there a three transactions that occur in the three month time period, then the number will be three.

At step 906, gaps between the transactions are evaluated. An estate account confidence score determination engine can determine the gaps between the transactions. A gap between the transactions can include how much time passes between adjacent transactions with a single payee. For example, in some embodiments, if transactions occur exactly a month apart, then the gap between the adjacent transactions will be a month.

At step 908, transaction amounts of the transactions are evaluated. An estate account confidence score determination engine can determine the transaction amount of the transactions. Transaction amounts include the amount of money that is transferred during each transaction.

At step 910, variances in the transaction amounts of the transactions are evaluated. An estate account confidence score determination engine can determine the variances in the transaction amount of the transactions. Variances in the transaction amounts include differences in transaction amounts between transactions.

At step 912, whitelists are evaluated. In evaluating whitelists it can be checked whether a party in the transactions is present on the whitelist, thereby suggesting that the transaction is associated with a potential estate account. An estate account confidence score determination engine can evaluate the whitelists.

At step 914, blacklists are evaluated. In evaluating blacklists it can be checked whether a party involved in each transaction is present on the blacklist, thereby suggesting that the transaction is not associated with a potential estate account. An estate account confidence score determination engine can evaluate the blacklists.

At step 916, an estate account confidence score is assigned, increased, decreased, and/or otherwise affected for each account based on the number of transactions in the time period, the gaps between the transactions, the transaction amounts, the variances in the transaction amounts, the whitelists, and/or the blacklists. In assigning, increasing, decreasing, and/or otherwise affecting a confidence score, the number of transactions can be compared to a transaction number threshold, the gaps between the transactions can be compared to a transaction gap threshold, the transaction amounts can be compared to a transaction amount threshold, and the variances in the transaction amounts can be compared to a transaction amount variance threshold.

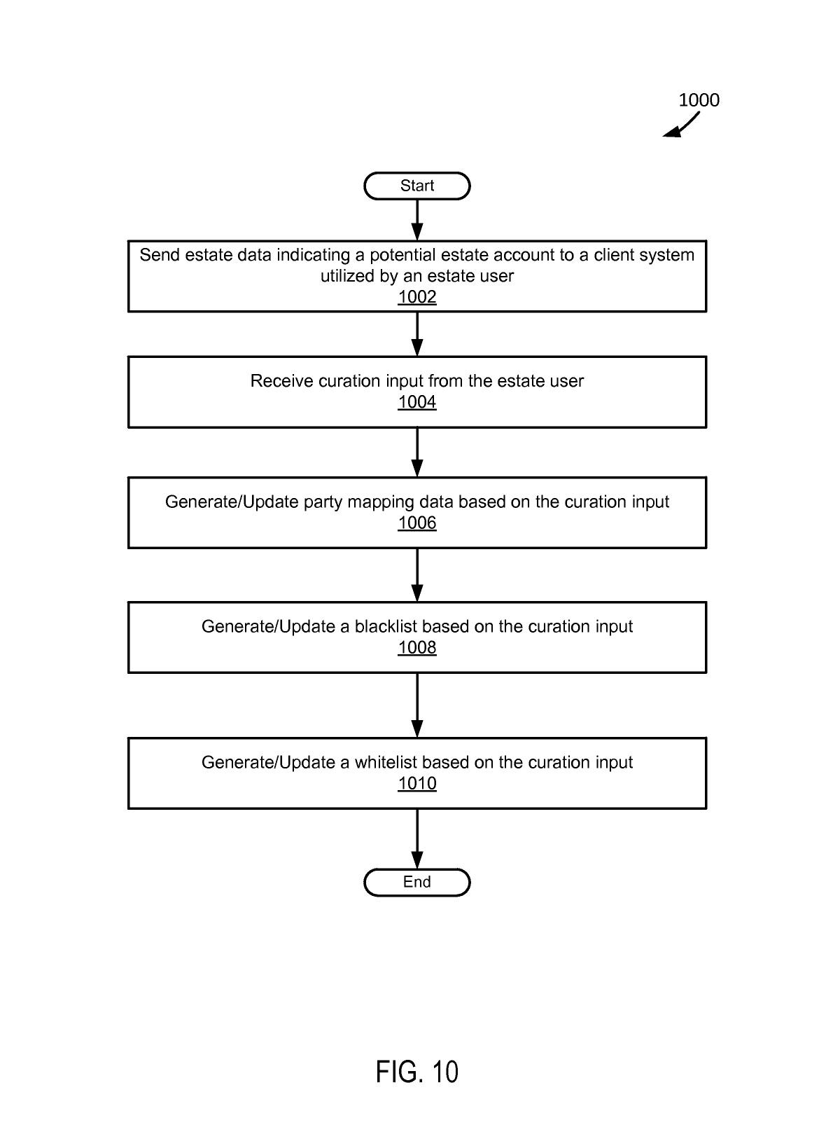

FIG. 10 is a flowchart of an example of a method 1000 for using curation input to improve estate account detection. It is noted the steps in FIG. 10 are by way of illustration only, and that the method 1000 may include elements not explicitly depicted, and that all elements are not necessary to perform the method 1000.

At step 1002, estate data indicating a potential estate account is sent to a client system utilized by an estate user. Estate data sent to the client system can include identification of a discovered potential estate account, one or more transactions used in discovering the account, parties of the one or more transactions, an estate account confidence score for the discovered potential estate account, amounts of money transferred in the one or more transactions, and dates when the transactions occurred.

At step 1004, curation input is received from the estate user. Curation input can include whether the potential estate account is indeed estate accounts for the estate, identification of the common name of the service provider associated with the potential estate account, identification of the service provider in financial data, and/or one or more categories of service provided by the service provider.

At step 1006, party mapping data is generated/updated based on the curation input. Party mapping data can be generated/updated by an estate account learning engine. For example, the party mapping data can be updated to reflect the identification of the more common name of the service provider so that the service provider can be identified by its more common name in the future to avoid incorrect curation input by others.

At step 1008, a blacklist is generated/updated based on the curation input. A blacklist can be generated/updated by an estate account learning engine. For example, if the curation input indicates an account is not for a service provider of an estate account, then the party identified by the account can be added to the blacklist, if it is decided that the reason for the removal is that the party and/or category of party is likely never a service provider of an estate account.

At step 1010, a whitelist is generated/updated based on the curation input. A whitelist can be generated/updated by an estate account learning engine. For example, if the curation input indicates an account is for a service provider of an estate account, then the party identified by the account can be added to the whitelist, if it is decided that the reason for the addition is that the party and/or category of party is likely always a service provider of an estate account.

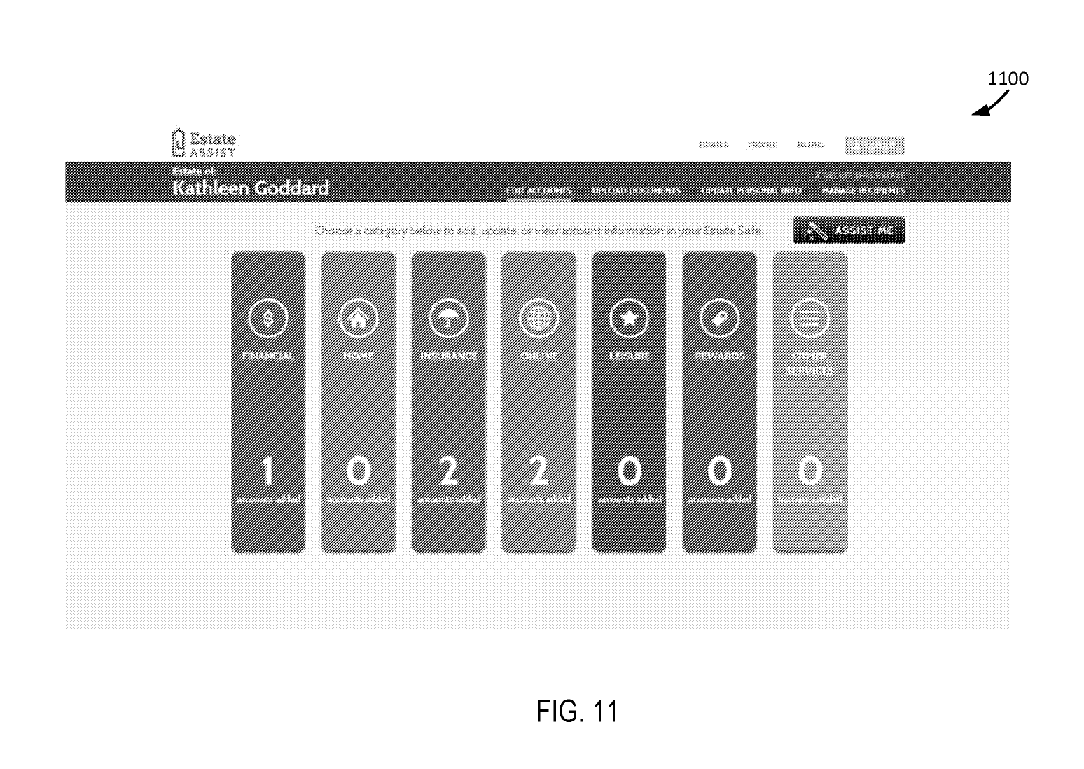

FIG. 11 is a screenshot of an example interface 1100 for managing discovered estate accounts. The interface 1100 includes links to structures where discovered estate accounts can be grouped. The discovered estate accounts can be grouped according to a service that is the subject of the estate accounts.

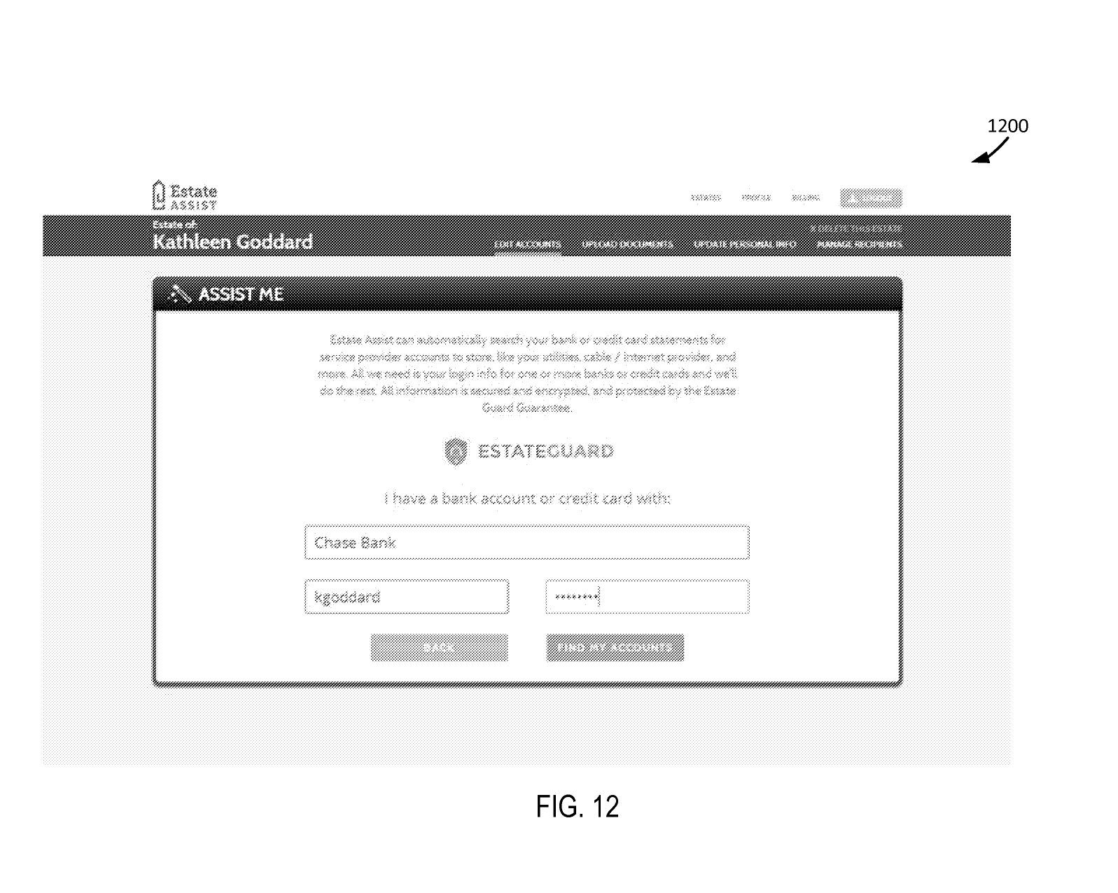

FIG. 12 is a screenshot of an example interface 1200 for inputting financial account login information. The interface 1200 includes fields into which an identification of a financial account provider can be entered, a username of an owner of an estate can be entered, and a password used to access the financial account can be entered.

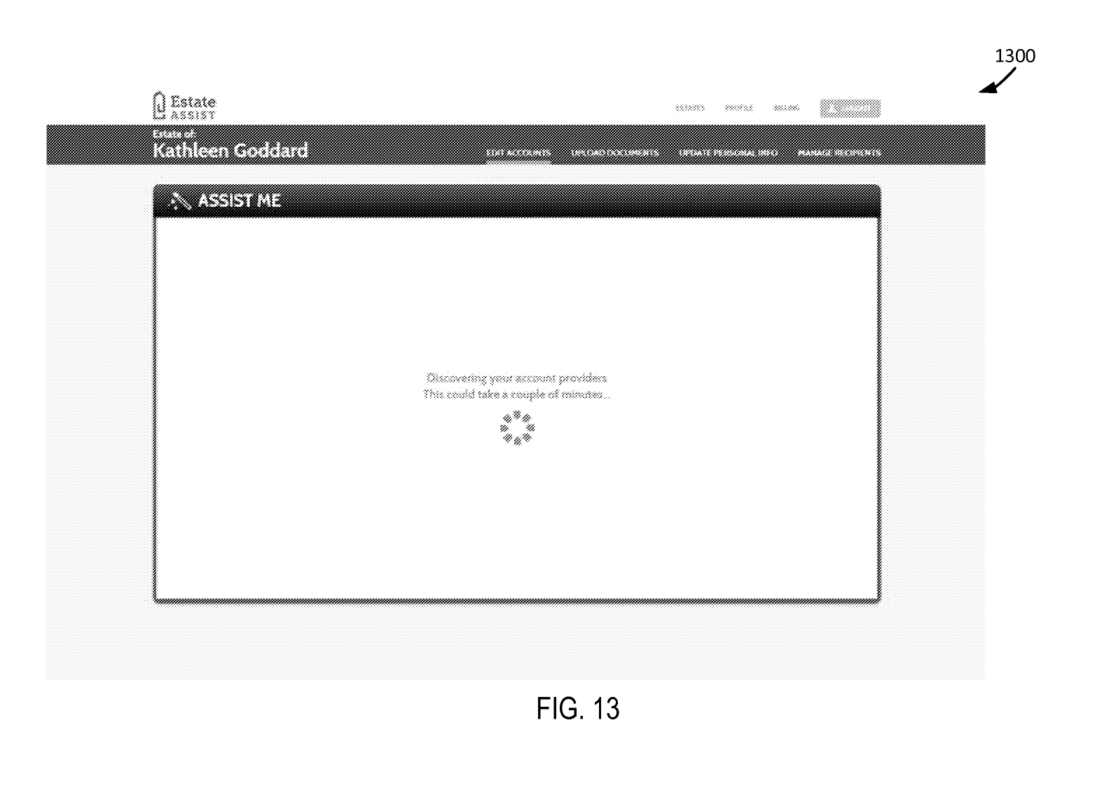

FIG. 13 is a screenshot of an example interface 1300 illustrating the discovering of potential estate accounts. The potential estate accounts can be discovered using various methods and systems described in this paper.

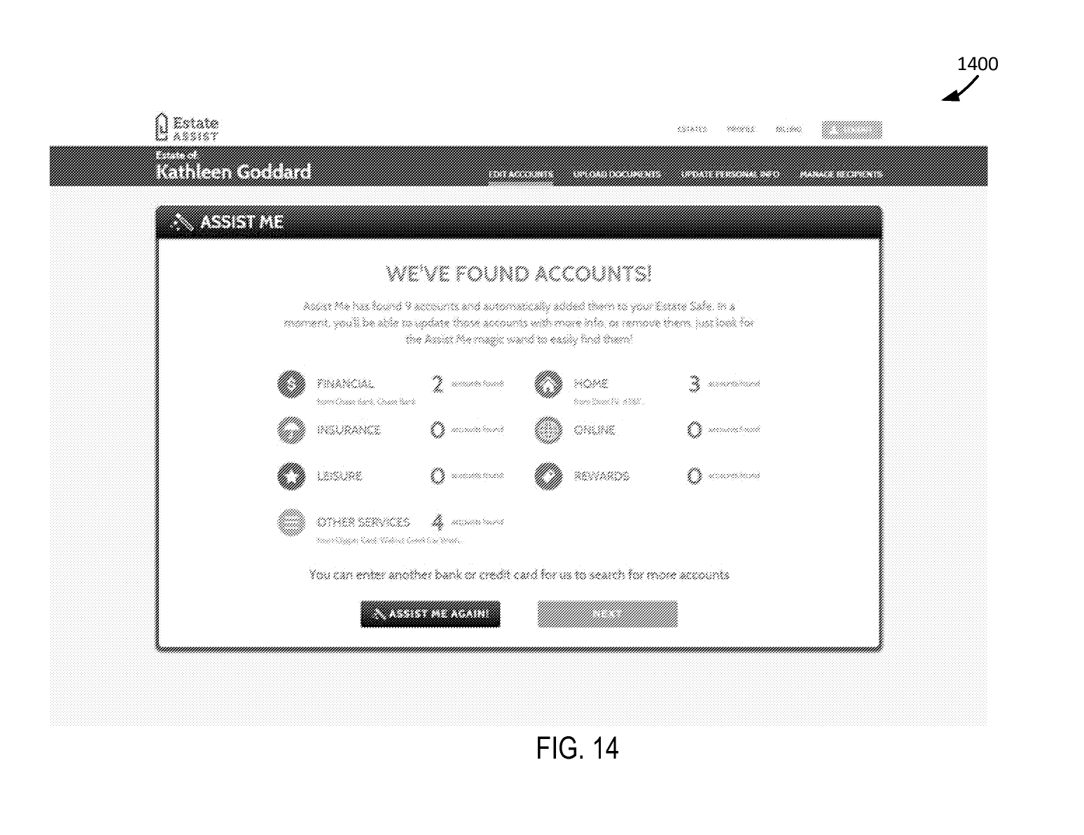

FIG. 14 is a screenshot of an example interface 1400 for displaying a number of discovered potential estate accounts to an estate user. The interface can display categories of service providers of the estate accounts. For example, in the interface 1400 two financial accounts are found, three home accounts are found, and four other (unidentified category) service provider accounts are found.

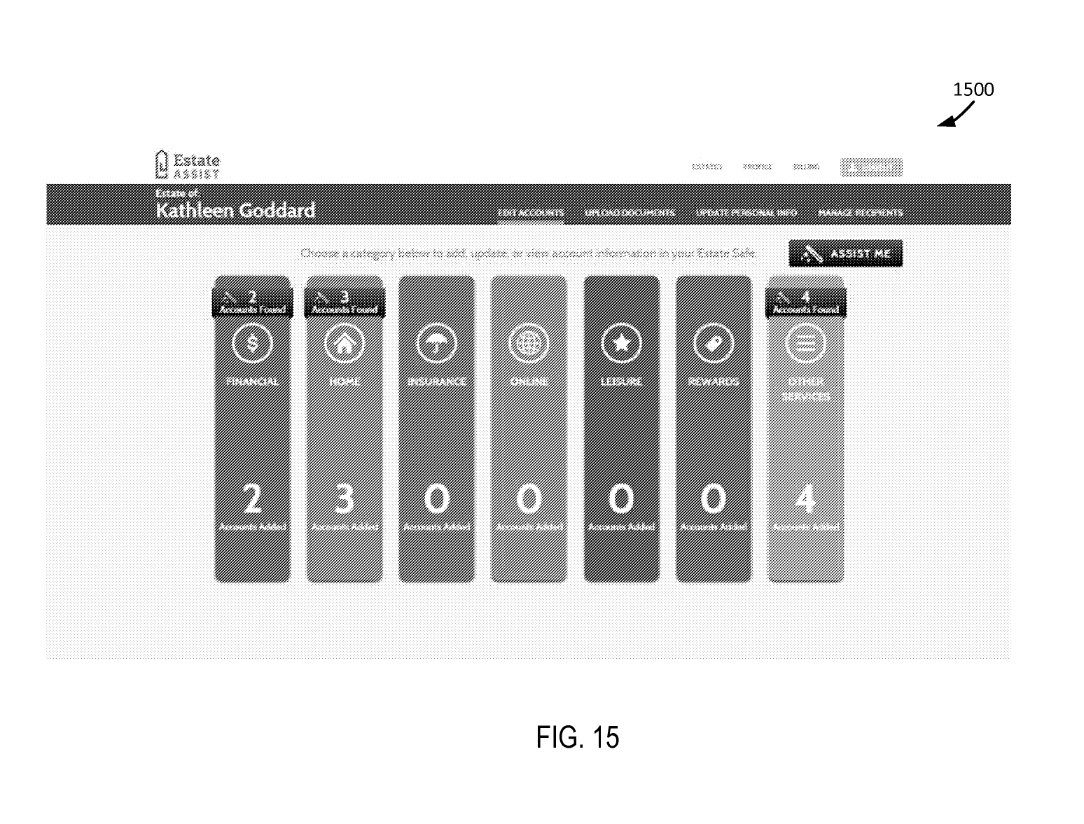

FIG. 15 is a screenshot of an example interface 1500 for allowing a user to interact with the system in curating the potential estate accounts. The interface 1500 includes links, organized by service provider type of the accounts, through which an estate user can view the potential estate accounts to determine if they are estate accounts.

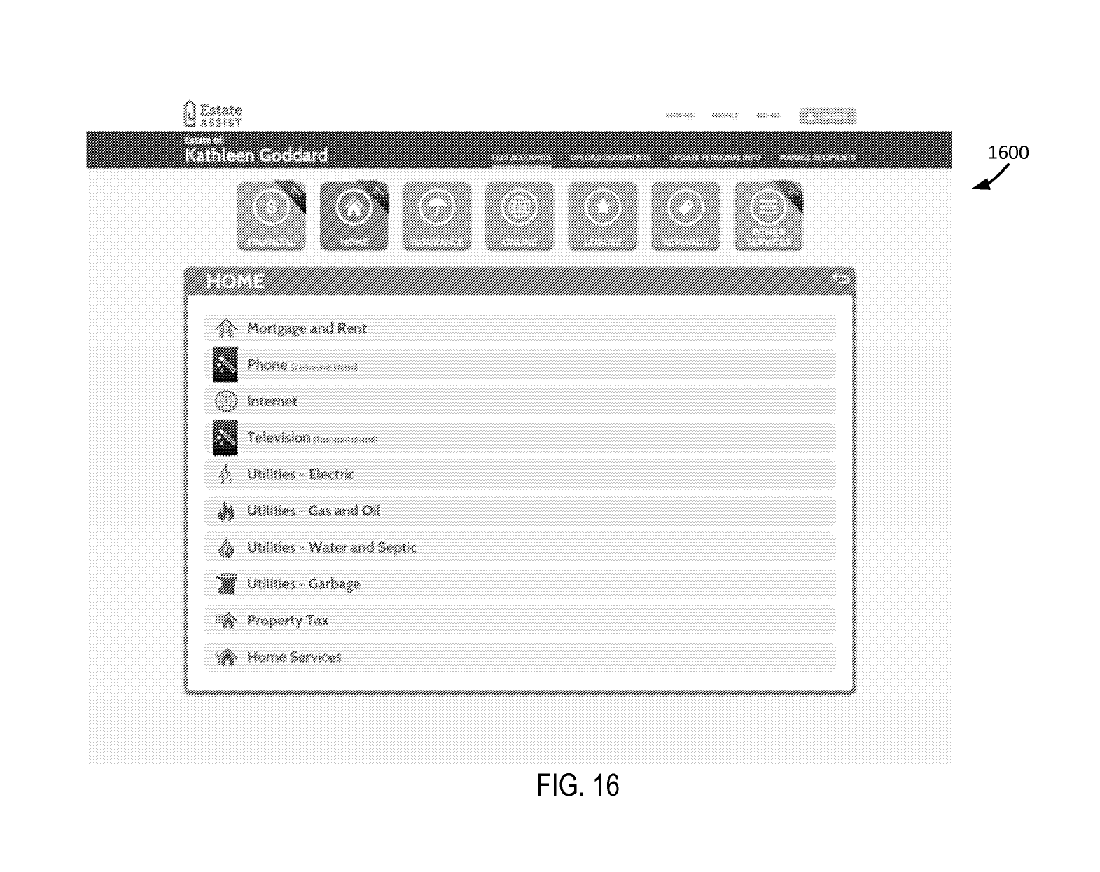

FIG. 16 is a screenshot of an example interface 1600 for allowing a user to view accounts with service providers within a service provider type. In the interface 1600, the accounts within the home service provider type are shown. The accounts within the home service provider type can include, mortgage and rent service providers, phone service providers, internet service providers, television service providers, utility providers, property tax service providers, and home services providers.

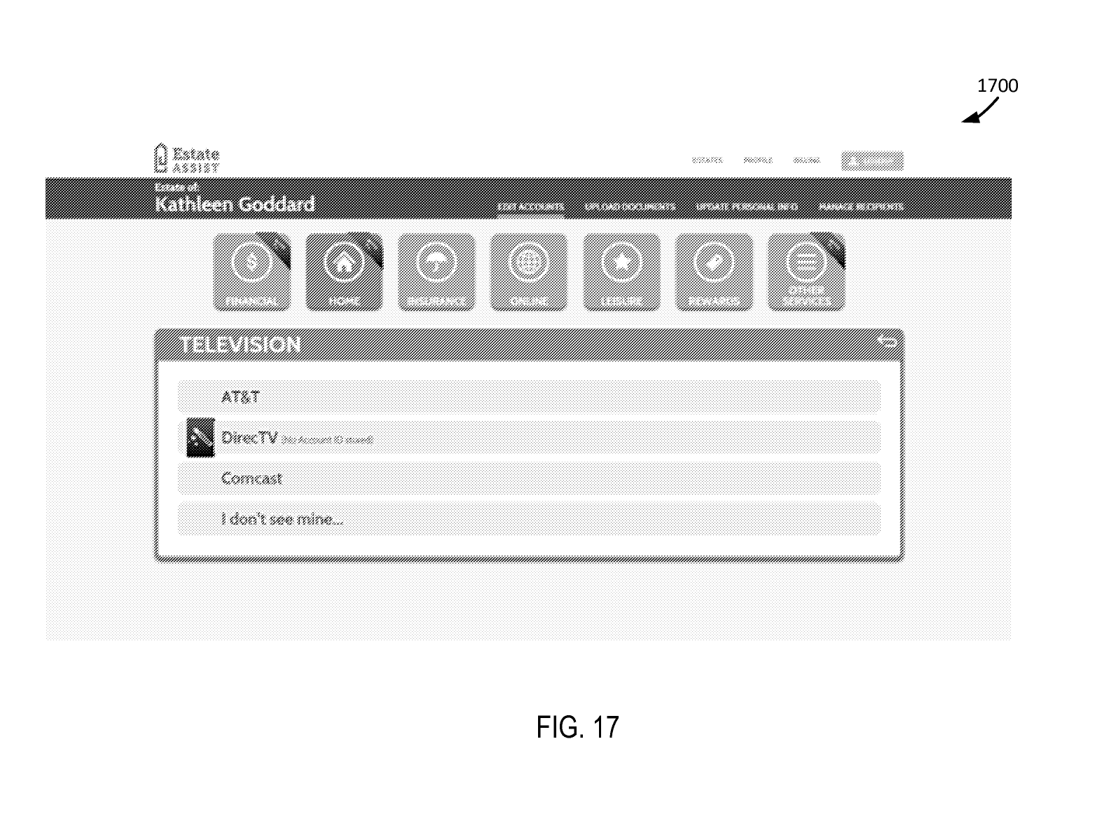

FIG. 17 is a screenshot of an example interface 1700 through which an estate user can enter and/or review estate accounts for a particular category of accounts (e.g., television). Through the interface 1700 an estate user can select, edit or remove a service provider for an estate account. The interface includes common service providers within the television type of service provider. The service providers may be identified through crowd-sourcing.

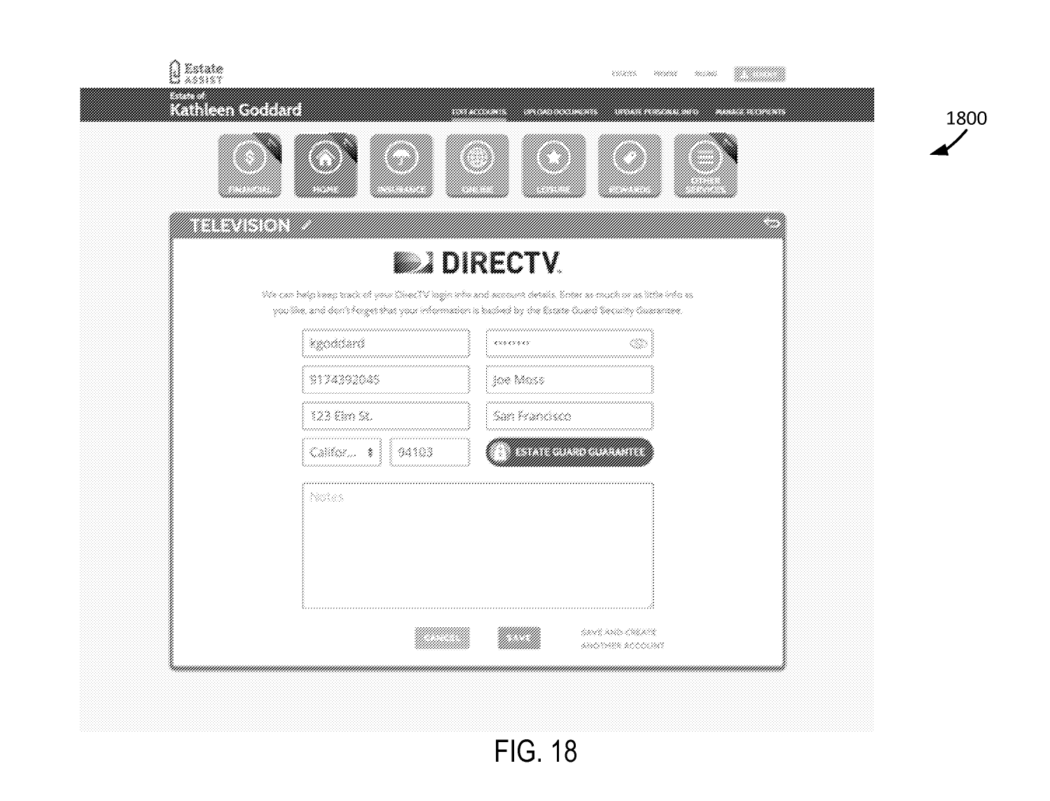

FIG. 18 is a screenshot of an example interface 1800 through which an estate user can provide and/or edit estate account data for an estate account. The interface 1800 includes a plurality of fields in which estate account data for an estate account can be entered, e.g., automatically or manually. For example, the interface 1800 includes an address of an estate owner, username, password, and estate account information.

1. A system comprising:
at least one processor;
at least one communications engine executable by the at least one processor for receiving a request to determine potential service provider accounts that a user has with one or more service providers and for obtaining financial data records of the user from an application programming interface that obtains the financial data records of the user from a financial provider system, each respective financial data record corresponding to a respective transaction and including a respective date, a respective amount, and a respective party identifier corresponding to a respective party associated with the respective transaction;
a confidence score determination engine executable by the at least one processor for evaluating the financial data records to generate at least one confidence score corresponding to at least one party, the confidence score indicating a likelihood that the user has a service provider account with the party; and
a potential service provider account identification engine executable by the at least one processor for identifying the potential service provider account based on the at least one confidence score.

2. The system of claim 1, wherein the confidence score determination engine generates each confidence score based on gaps between transactions and variance in transaction amounts.

3. The system of claim 1, wherein the financial data records of the user include at least three months of financial data records of the user.

4. The system of claim 1, further comprising an estate account learning engine executable by the at least one processor for identifying party identifiers who are unlikely to correspond to service providers.

5. The system of claim 4, wherein each financial data record further includes a category.

6. The system of claim 5, wherein the party identifiers who are unlikely to correspond to services providers include all party identifiers corresponding to a particular category.

7. The system of claim 1, further comprising a learning engine executable by the at least one processor, the learning engine for obtaining crowd-sourced data to identify party identifiers that are highly unlikely to correspond to service providers.

8. The system of claim 1, further comprising a learning engine executable by the at least one processor, the learning engine for obtaining crowd-sourced data to associate party identifiers to more common company names, so that users can more easily identify likely service providers.

9. The system of claim 1, further comprising a learning engine executable by the at least one processor, the learning engine for obtaining crowd-sourced data to identify party identifiers of parties users have identified as service providers.

10. A method comprising:
receiving a request to determine potential service provider accounts that a user has with one or more service providers;
obtaining financial data records of the user from an application programming interface that obtains the financial data records of the user from a financial provider system, each respective financial data record corresponding to a respective transaction and including a respective date, a respective amount, and a respective party identifier corresponding to a respective party associated with the respective transaction;
evaluating the financial data records to generate at least one confidence score corresponding to at least one party, the confidence score indicating a likelihood that the user has a service provider account with the party; and
identifying the potential service provider account based on the at least one confidence score.

11. The method of claim 10, wherein each confidence score is based on gaps between transactions and variance in transaction amounts.

12. The method of claim 10, wherein the financial data records of the user include at least three months of financial data records of the user.

13. The method of claim 10, further comprising identifying party identifiers who are unlikely to correspond to service providers.

14. The method of claim 13, wherein each financial data record further includes a category.

15. The method of claim 14, wherein the party identifiers who are unlikely to correspond to services providers include all party identifiers corresponding to a particular category.

16. The method of claim 10, further comprising obtaining crowd-sourced data to identify party identifiers that are highly unlikely to correspond to service providers.

17. The method of claim 10, further comprising obtaining crowd-sourced data to associate party identifiers to more common company names, so that users can more easily identify likely service providers.

18. The method of claim 10, further comprising obtaining crowd-sourced data to identify party identifiers of parties users have identified as service providers.

19. A system comprising:
means for receiving a request to determine potential service provider accounts that a user has with one or more service providers;
means for obtaining financial data records of the user from an application programming interface that obtains the financial data records of the user from a financial provider system, each respective financial data record corresponding to a respective transaction and including a respective date, a respective amount, and a respective party identifier corresponding to a respective party associated with the respective transaction;
means for evaluating the financial data records to generate at least one confidence score corresponding to at least one party, the confidence score indicating a likelihood that the user has a service provider account with the party; and
means for identifying the potential service provider account based on the at least one confidence score.
